(19) United States
(12) Patent Application Publication
(10) Pub. No.: US 2015/0029108 A1
(43) Pub. Date: Jan. 29, 2015

(54) TOUCH PANEL, TOUCH SENSOR AND METHOD FOR MANUFACTURING THE SAME

(71) Applicant: HengHao Technology Co., LTD, Taoyuan County (TW)

(72) Inventor: YI-PENG KUO, Taoyuan County (TW)

(73) Assignee: HengHao Technology Co., LTD, Taoyuan County (TW)

(21) Appl. No.: 14/044,764

(22) Filed: Oct. 2, 2013

(30) Foreign Application Priority Data
Jul. 25, 2013 (TW) 102126770

(51) Int. Cl. G06F 3/041; H04N 13/04; G02B 27/22

(52) U.S. Cl. CPC G06F 3/0412; G02B 27/2214; H04N 13/0404
USPC 345/173; 29/825

(57) ABSTRACT

A touch sensor, a method for manufacturing same and a touch panel having the touch sensor are disclosed. The sensor may include a touch sensing layer and an auto-stereoscopic image generating structure. In particular, the touch sensing layer may act as a substrate for the auto-stereoscopic image generating structure to be directly formed on, such that the thickness of the touch sensor can be further reduced.

### CROSS-REFERENCE TO RELATED APPLICATION

This application claims the benefit of Taiwan Patent Application No. 102126770, filed on Jul. 25, 2013, in the Taiwan Intellectual Property Office, the disclosure of which is incorporated herein in its entirety by reference.

### BACKGROUND OF THE INVENTION

1. Field of the Invention

The present invention generally relates to a touch sensor, in particular to a touch sensor which combines a touch sensing layer with an auto-stereoscopic image generating structure. The present invention further relates to the method for manufacturing the touch sensor and the touch panel having the touch sensor.

2. Description of Related Art

A touch panel, with integrating touch sensor and display panel, is convenient and easy to use. The touch panel can be seen in not a few electronic devices, such as portable electronic devices and the like. For the purpose of conforming to the future trends, on one hand, touch panel integrating touch sensing technique and auto-stereoscopic display technique is developed. On the other hand, more new touch sensing techniques are also developed, especially the One File Solution (OFS). The One File Solution has become one of the most popular touch sensing techniques as it is thinner and lighter than One Glass Solution (OGS). However, the conventional touch panels still have a great number of shortcomings needing to be improved.

With reference to FIG. 1 for a conventional touch panel with auto-stereoscopic display function, as show in FIG. 1, the touch panel 1 comprises a cover glass, a touch sensor, an auto-stereoscopic image generation structure, a color filter, a TFT array and a backlight module. In this case, the auto-stereoscopic image generation structure of the touch panel 1 needs to be manufactured on a substrate before bonded to the touch sensor. In this way, the touch panel 1 can have auto-stereoscopic display function. However, for one thing, the substrate will significant increase the manufacturing cost of the touch panel 1; for another, it will also raise the thickness and weight of the touch panel 1.

Taiwan Patent No. M419191 also discloses a display device with both touch and auto-stereoscopic display function; in this case, the auto-stereoscopic image generation structure (lenticular lens) is bonded to the back plate of the touch panel. Similarly, the auto-stereoscopic image generation structure has to be manufactured on a substrate; afterward the substrate is bonded to the back plate of the touch panel, which also results in the same problems as the touch panel in FIG. 1. Taiwan Patents No. M410923 and Taiwan Patents No. M413123 have the same shortcomings, too.

Therefore, it is imperative to develop a touch sensor applicable to a touch panel to reduce the manufacturing cost, and decrease the thickness and weight of the conventional touch panel.

### SUMMARY OF THE INVENTION

Therefore, it is a primary objective of the present invention to provide a touch sensor with auto-stereoscopic image generating structure to decrease the manufacturing cost of the touch panel, and its thickness and weight.

To achieve the foregoing objective, the present invention provides a touch sensor.

The touch sensor may comprise a touch sensing layer and an auto-stereoscopic image generating structure, wherein the touch sensing layer may act as a substrate for the auto-stereoscopic image generating structure to be directly formed on.

To achieve the foregoing objective, the present invention further provides a method for manufacturing a touch sensor. The method may comprise the following steps:

providing a touch sensing layer; and using the touch sensing layer as a substrate to directly form an auto-stereoscopic image generating structure on the touch sensing layer.

In a preferred embodiment of the present invention, the touch sensing layer may be a one film solution (OFS).

In a preferred embodiment of the present invention, the auto-stereoscopic image generating structure may be a parallax barrier layer, and the parallax barrier layer may comprise a plurality of parallax barriers.

In a preferred embodiment of the present invention, the parallax barrier layer may be formed by exposing and developing a shading light-sensitive layer.

In a preferred embodiment of the present invention, the parallax barrier layer may be formed by a printing process or a transfer printing process.

In a preferred embodiment of the present invention, the parallax barrier layer may be formed by a sputtering process or an evaporation process.

In a preferred embodiment of the present invention, the auto-stereoscopic image generating structure may be a lenticular lens layer, and the lenticular lens layer may comprise a plurality of lenticular lenses.

In a preferred embodiment of the present invention, the lenticular lens layer may be formed by using a half-tone mask to expose and develop a transparent lighting-sensitive layer.

The touch panel, touch sensor and the method for manufacturing the same according to the present invention has the following advantages:

(1) In a preferred embodiment of the present invention, the touch sensor comprises both the auto-stereoscopic image generating structure and the touch sensing layer, such that the touch sensor can have auto-stereoscopic display function, which adds the additional function to the touch sensor.

(2) In a preferred embodiment of the present invention, the touch sensing layer acts as a substrate for the auto-stereoscopic image generating structure to be directly formed on, which not only can significant reduce the manufacturing cost of the touch panel and but also decrease its thickness and weight.

(3) In a preferred embodiment of the present invention, the touch sensor integrates one film solution and lenticular lens or parallax barriers, which can further lower the manufacturing cost of the touch panel and reduce its thickness and weight.

(4) The preferred embodiments of the prevent invention discloses several effective ways to directly form the auto-stereoscopic image generating structures on the one film solution.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a schematic view of a conventional touch panel with the auto-stereoscopic display function.

FIGS. 2A and 2B are schematic views of one embodiment of the touch panel with auto-stereoscopic display function in accordance with the present invention.

FIGS. 3A and 3B are schematic views of one embodiment of the touch sensor with auto-stereoscopic image generating structure in accordance with the present invention.

FIGS. 4A and 4B are schematic views of one embodiment of the touch sensor with auto-stereoscopic image generating structure in accordance with the present invention.

FIGS. 5A and 5B are schematic views of one embodiment of the touch sensor with auto-stereoscopic image generating structure in accordance with the present invention.

FIG. 6 is a schematic view of one embodiment of the touch sensor with auto-stereoscopic image generating structure in accordance with the present invention.

FIG. 7 is a schematic view of one embodiment of the touch sensor with auto-stereoscopic image generating structure in accordance with the present invention.

FIGS. 8A and 8B are schematic views of one embodiment of the touch sensor with auto-stereoscopic image generating structure in accordance with the present invention.

FIG. 9 is a flow chart of one embodiment of a manufacturing method for a touch sensor in accordance with the present invention.

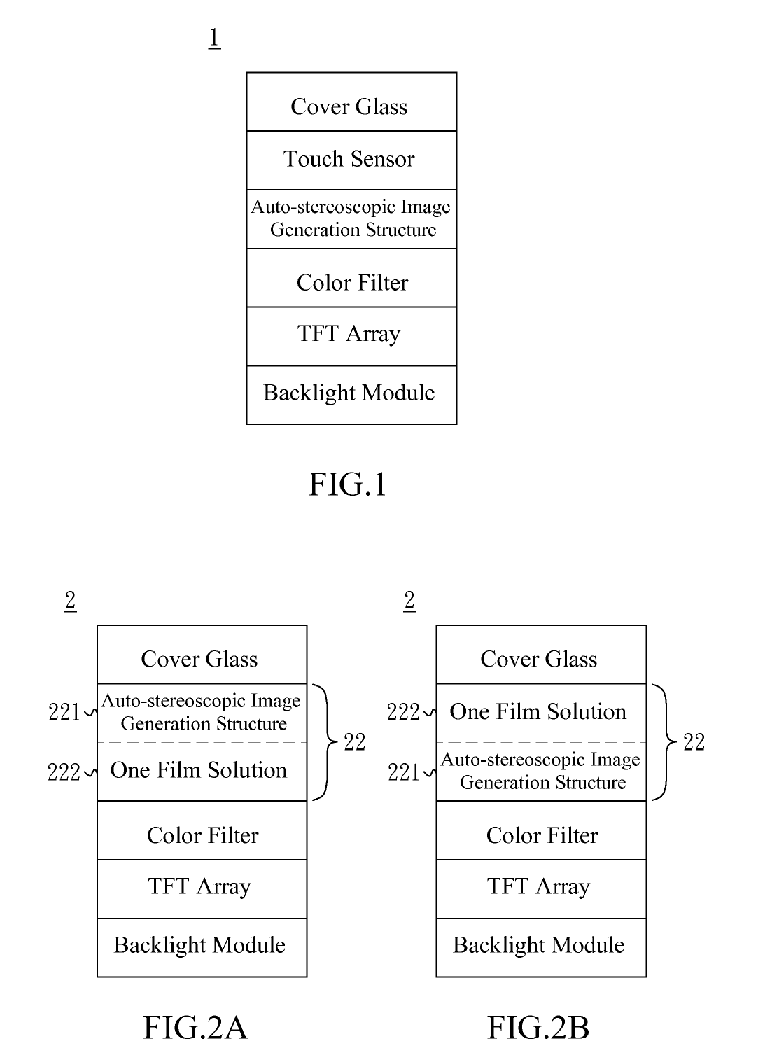

### DETAILED DESCRIPTION OF THE PREFERRED EMBODIMENTS

The detailed description of the present invention will be discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components. Some components are not drawn according to their original size, which may be magnified or simplified for the purpose of specifying the invention. Although specific embodiments have been illustrated and described, it will be appreciated by those skilled in the art that various modifications may be made without departing from the scope of the present invention, which is intended to be limited solely by the appended claims.

Please refer to FIG. 2A and FIG. 2B, which portray schematic views of one embodiment of the touch panel with auto-stereoscopic display function in accordance with the present invention. As shown in FIG. 2A and FIG. 2B, the touch panel 2 may comprise a cover glass, a touch sensor 22, a color filter, a TFT array and a backlight module.

The touch sensor 22 may comprise an auto-stereoscopic image generating structure 221 and a touch sensing layer 222. The touch sensing layer 222 may be a lot of types. The embodiment use the one film solution (OFS) as the touch sensing layer 222, which is just an example instead of a limitation. The touch sensing layer 222 may act as a substrate for the auto-stereoscopic image generating structure 221 to be directly formed on. In the embodiment, the touch sensing layer 222 is one film solution, which is characterized by its extremely low thickness and weight; therefore, the thickness and weight of the touch panel 2 can be further reduced.

It is worth noting that the touch sensing layer 222, in the above embodiment, comprises the auto-stereoscopic image generating structure 221 and the touch sensing layer 222, such that the touch sensor 22 can have auto-stereoscopic display function, which adds the additional function to the touch sensor 222.

Besides, the auto-stereoscopic image generating structure 221 may be a parallax barrier layer composed of a plurality of parallax barriers, or a lenticular lens layer composed of a plurality of lenticular lenses, or the like.

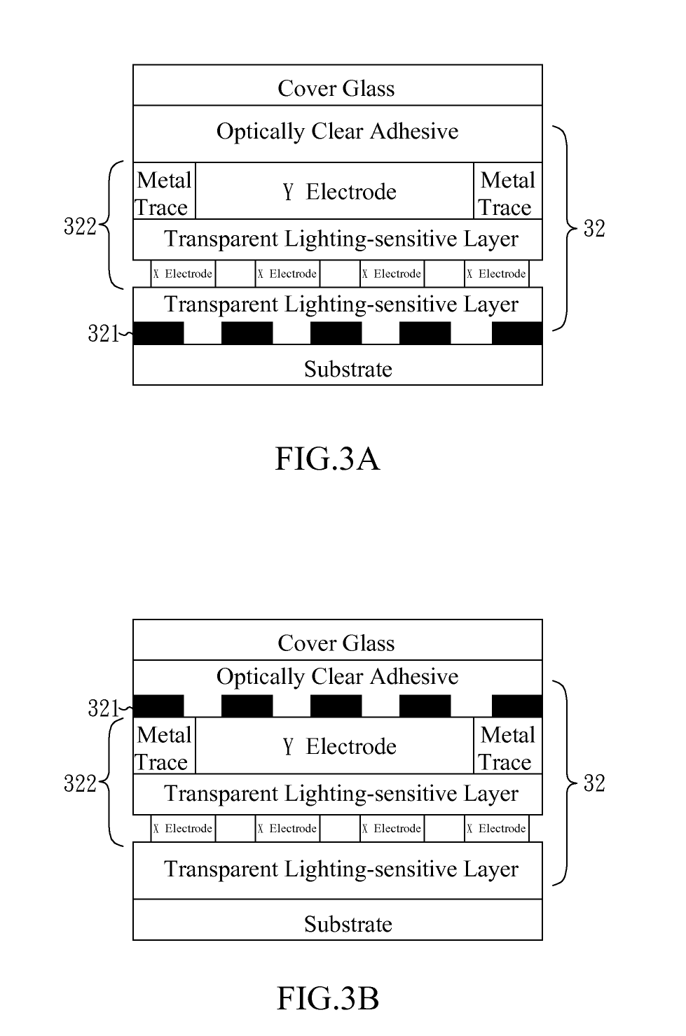

Please refer to FIG. 3A and FIG. 3B, schematic views of one embodiment of the touch sensor with auto-stereoscopic image generating structure in accordance with the present invention. FIG. 3A and FIG. 3B illustrates a touch sensor 32 integrating a one film solution 322 and a parallax barrier layer 321.

The parallax barriers of the parallax barrier layer 321 can be form on the one film solution 322 by means of various methods. For example, we can from the strip pattern to act as the parallax barriers by exposing and developing a shading light-sensitive layer, or by a printing process or a transfer printing process, or by a sputtering process or an evaporation process. The aforementioned methods are just for example rather than limitation.

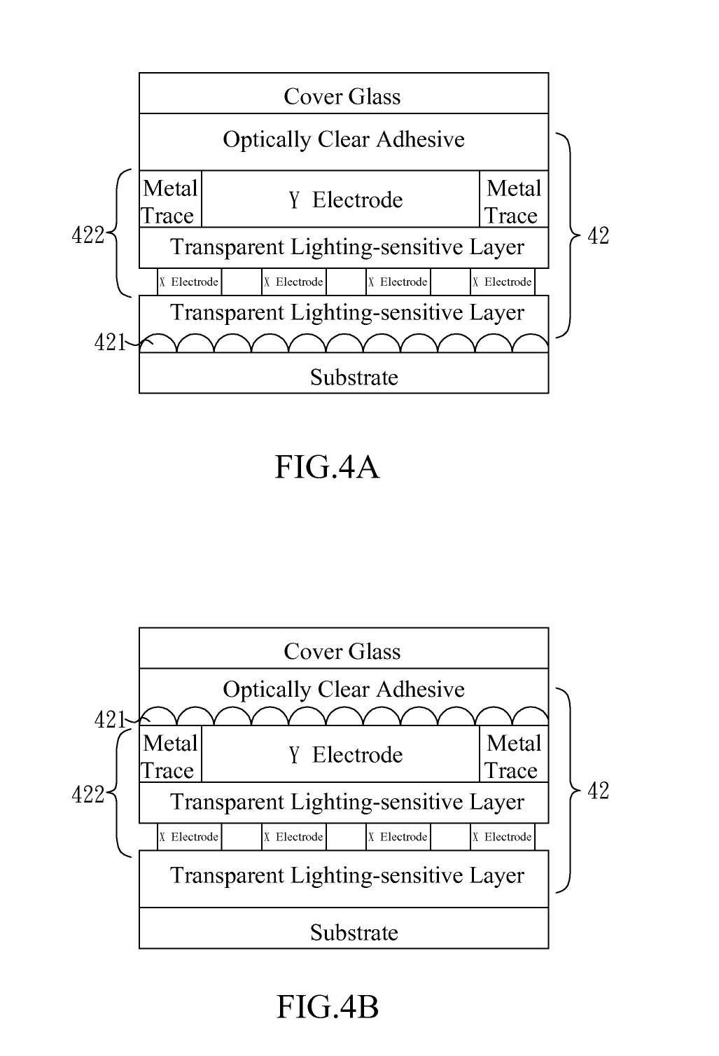

Please refer to FIG. 4A and FIG. 4B, schematic views of one embodiment of the touch sensor with auto-stereoscopic image generating structure in accordance with the present invention. FIG. 4A and FIG. 4B illustrates a touch sensor 42 integrating a one film solution 422 and a lenticular lens layer 421.

Similarly, the lenticular lenses of the lenticular lens layer 421 can be form on the one film solution 422 by means of various methods. In a preferred embodiment, we can form the lenticular les layer 421 lens by using a half-tone mask to expose and develop a transparent lighting-sensitive layer. The aforementioned methods are just for example rather than limitation.

It is worth noting that the touch sensor, in the aforementioned embodiment, integrates various auto-stereoscopic image generating structures and the one film solution. Also, these embodiments also disclose various methods to use the one film solution as the substrate for the auto-stereoscopic image generating structure to directly form on. Further, the one film solution is characterized by its extremely low thickness and weight.

Therefore, the touch panel having the touch sensor can have both auto-stereoscopic display function and touch function. Besides, the manufacturing cost, thickness and weight of the touch panel can be further reduced. The previous embodiments can definitely improve the shortcomings of the conventional touch panel.

In addition, the above embodiments further disclose several most effective ways to use the one film solution as the substrate for the auto-stereoscopic image generating structure to directly form on; hence, those skilled in the art can practice the invention without experiments.

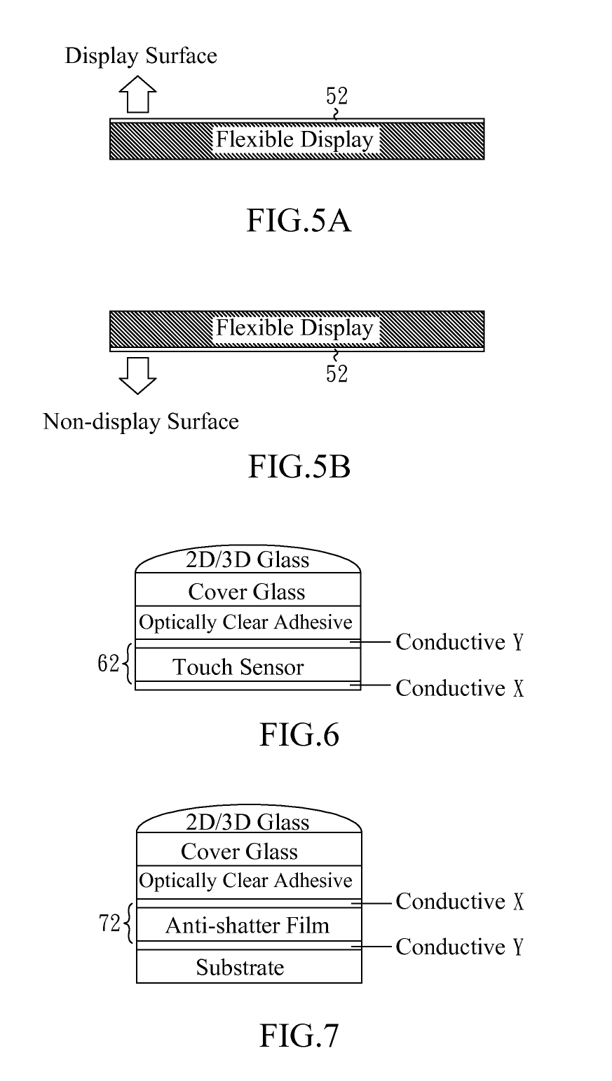

Please refer to FIG. 5A and FIG. 5B, schematic views of one embodiment of the touch sensor with auto-stereoscopic image generating structure in accordance with the present invention. As shown in FIG. 5A, the touch sensor 52 combing auto-stereoscopic image generating structure and one film solution can be directly manufactured on the display surface of the flexible display. As shown in FIG. 5B, the touch sensor 52 combing auto-stereoscopic image generating structure and one film solution can be directly manufactured on the non-display surface of the flexible display.

Please refer to FIG. 6, a schematic view of one embodiment of the touch sensor with auto-stereoscopic image generating structure in accordance with the present invention.

As shown in FIG. 6, the touch sensor 62 combing auto-stereoscopic image generating structure and one film solution can also be applied to 2D/3D touch display. The touch sensor 62 can be directly manufactured on the 2D/3D glass to make it have both auto-stereoscopic display function and touch function.

Please refer to FIG. 7, a schematic view of one embodiment of the touch sensor with auto-stereoscopic image generating structure in accordance with the present invention. Similarly, the touch sensor 72 can be directly manufactured on a glass-film-film (GFF) type structure to make it have both auto-stereoscopic display function and touch function.

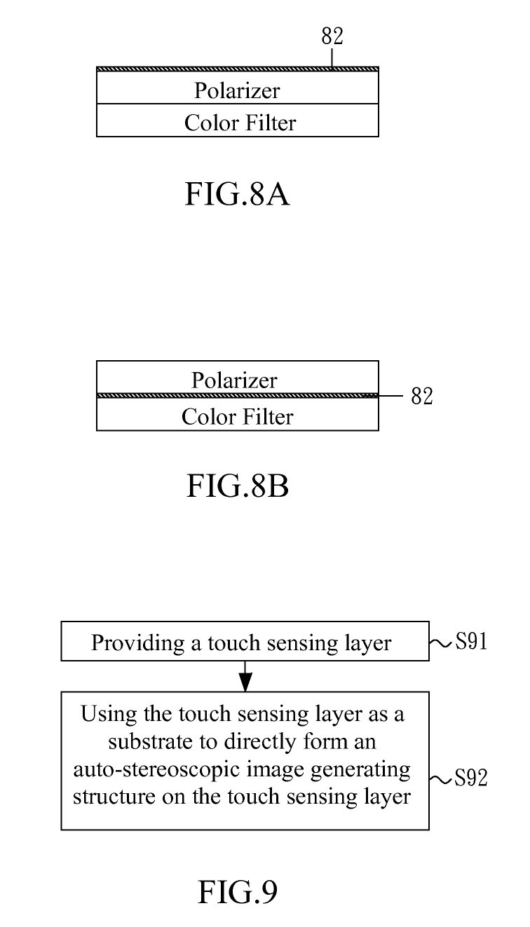

Please refer to FIG. 8A and FIG. 8B, schematic views of one embodiment of the touch sensor with auto-stereoscopic image generating structure in accordance with the present invention. As shown in FIG. 8A, the touch sensor 82 combing auto-stereoscopic image generating structure and one film solution can be directly manufactured on the top layer of the polarizer. As shown in FIG. 8B, the touch sensor 82 combing auto-stereoscopic image generating structure and one film solution can be directly manufactured on the bottom layer of the polarizer.

Although the above description about the touch sensor in accordance with the present invention has illustrated the concept of the manufacturing method for the touch sensor in accordance with the present invention, the following still provides the flow chart to specify the manufacturing method in accordance with the present invention.

Please refer to FIG. 9, a flow chart of one embodiment of a manufacturing method for a touch sensor in accordance with the present invention. The method may comprise the following steps:

Step S91: providing a touch sensing layer.

Step S92: using the touch sensing layer as a substrate to directly form an auto-stereoscopic image generating structure on the touch sensing layer.

The detailed description and the exemplary embodiments of the manufacturing method in accordance with the present invention have been described in the description of the touch sensor; therefore, they will not be repeated herein again.

In summation of the description above, a preferred embodiment of the present invention discloses the touch sensor comprising both the auto-stereoscopic image generating structure and the touch sensing layer, such that the touch sensor can have auto-stereoscopic display function, which adds the additional function to the touch sensor. A preferred embodiment of the present invention discloses that the touch sensing layer may act as a substrate for the auto-stereoscopic image generating structure to be directly formed on, which not only can substantially lower the manufacturing cost of the touch panel and but also reduce its thickness and weight. Besides, a preferred embodiment of the present invention discloses that the touch sensor may integrate one film solution and lenticular lens or parallax barriers, which can further reduce the manufacturing cost of the touch panel and decrease its thickness and weight. Furthermore, the preferred embodiments of the prevent invention discloses several effective ways to directly form the auto-stereoscopic image generating structures on the one film solution, such that those skilled in the art can practice the invention without difficulties.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A touch sensor, comprising:
a touch sensing layer; and
an auto-stereoscopic image generating structure, wherein the touch sensing layer acts as a substrate for the auto-stereoscopic image generating structure to be directly formed on.

2. The touch sensor of claim 1, wherein the touch sensing layer is a one film solution (OFS).

3. The touch sensor of claim 2, wherein the auto-stereoscopic image generating structure is a parallax barrier layer, and the parallax barrier layer comprises a plurality of parallax barriers.

4. The touch sensor of claim 3, wherein the parallax barrier layer is formed by exposing and developing a shading light-sensitive layer.

5. The touch sensor of claim 3, wherein the parallax barrier layer is formed by a printing process or a transfer printing process.

6. The touch sensor of claim 3, wherein the parallax barrier layer is formed by a sputtering process or an evaporation process.

7. The touch sensor of claim 2, wherein the auto-stereoscopic image generating structure is a lenticular lens layer, and the lenticular lens layer comprises a plurality of lenticular lenses.

8. The touch sensor of claim 7, wherein the lenticular lens layer is formed by using a half-tone mask to expose and develop a transparent lighting-sensitive layer.

9. A method for manufacturing a touch sensor, comprising the following steps:
providing a touch sensing layer; and
using the touch sensing layer as a substrate to directly form an auto-stereoscopic image generating structure on the touch sensing layer.

10. The method of claim 9, wherein the touch sensing layer is a one film solution.

11. The method of claim 10, wherein the auto-stereoscopic image generating structure is a parallax barrier layer, and the parallax barrier layer comprises a plurality of parallax barriers.

12. The method of claim 11, further comprising the following step:
forming the parallax barrier layer by exposing and developing a shading light-sensitive layer.

13. The method of claim 11, further comprising the following step:
forming the parallax barrier layer by a printing process or a transfer printing process.

14. The method of claim 11, further comprising the following step:
forming the parallax barrier layer by a sputtering process or an evaporation process.

15. The method of claim 10, wherein the auto-stereoscopic image generating structure is a lenticular lens layer, and the lenticular lens layer comprises a plurality of lenticular lenses.

16. The method of claim 11, further comprising the following step:
forming the lenticular lens layer by using a half-tone mask to expose and develop a transparent lighting-sensitive layer.

17. A touch panel comprising a backlight module and a touch sensor, and the touch sensor comprising:
a touch sensing layer; and
an auto-stereoscopic image generating structure, wherein the touch sensing layer acts as a substrate for the auto-stereoscopic image generating structure to be directly formed on.

18. The touch panel of claim 17, wherein the touch sensing layer is a one film solution.

19. The touch panel of claim 18, wherein the auto-stereoscopic image generating structure is a parallax barrier layer, and the parallax barrier layer comprises a plurality of parallax barriers.

20. The touch panel of claim 19, wherein the parallax barrier layer is formed by exposing and developing a shading light-sensitive layer.

21. The touch panel of claim 19, wherein the parallax barrier layer is formed by a printing process or a transfer printing process.

22. The touch panel of claim 19, wherein the parallax barrier layer is formed by a sputtering process or an evaporation process.

23. The touch panel of claim 18, wherein the auto-stereoscopic image generating structure is a lenticular lens layer, and the lenticular lens layer comprises a plurality of lenticular lenses.

24. The touch panel of claim 23, wherein the lenticular lens layer is formed by using a half-tone mask to expose and develop a transparent lighting-sensitive layer.
